(19) United States
(12) Patent Application Publication
(10) Pub. No.: US 2025/0211075 A1
(43) Pub. Date: Jun. 26, 2025

(54) METHOD FOR MANUFACTURING MOTOR CORE

(71) Applicant: TOYOTA BOSHOKU KABUSHIKI KAISHA, Aichi-ken (JP)

(72) Inventors: Daisuke HOMMA, Anjo-shi (JP); Yasunori SAKURAI, Hashima-shi (JP); Harutaka ODA, Toyota-shi (JP)

(73) Assignee: TOYOTA BOSHOKU KABUSHIKI KAISHA, Aichi-ken (JP)

(21) Appl. No.: 18/982,117

(22) Filed: Dec. 16, 2024

(30) Foreign Application Priority Data
Dec. 21, 2023 (JP) 2023-215815

(51) Int. Cl. H02K 15/027; H02K 15/40

(52) U.S. Cl. CPC H02K 15/027; H02K 15/40; H02K 2215/00

(57) ABSTRACT

A method for manufacturing a motor core includes forming multiple blocks, stacking the blocks to form a stacked body, and detecting an identifying portion with a detection device. The forming the blocks includes forming, only in the iron core piece that forms one end face of each block, an identifying portion for identifying the progressive press device that forms that block. The forming, only in the iron core piece that forms one end face of each block, the identifying portion includes forming the identifying portion in a surface of the iron core piece that forms the one end face of the block. The stacking the blocks to form the stacked body includes stacking, to form the stacked body, only the blocks formed by the progressive press device corresponding to the detected identifying portion among the multiple blocks.

### CROSS-REFERENCE TO RELATED APPLICATIONS

This application is based upon and claims the benefit of priority from Japanese Patent Application No. 2023-215815, filed on Dec. 21, 2023, the entire contents of which are incorporated herein by reference.

### BACKGROUND

### 1. Field

The present disclosure relates to a method for manufacturing a motor core.

### 2. Description of Related Art

A method for manufacturing a motor core formed by stacking multiple blocks includes a block forming step and a stacked body forming step. The block forming step includes punching multiple iron core pieces from a base material made of a magnetic steel sheet, and stacking the punched iron core pieces to form a block. The stacked body forming step includes stacking multiple blocks.

In the block forming step, a progressive press device is used. The progressive press device includes a lower die and an upper die, and is configured to punch iron core pieces in sequential steps. The lower die is provided with multiple punches, each shaped to match the punching areas in the iron core pieces at each stage. The upper die is provided with multiple punches respectively corresponding to the punches of the lower die. Through the coordinated operation of the punches in the lower and upper dies, iron core pieces are punched out from the base material.

In the above-described progressive press device, two rows of punches are arranged in the lower and upper dies along the width direction of the base material. This arrangement allows for two blocks to be formed simultaneously from the same base material.

In this progressive press device, a slight misalignment may occur between the center of the punch for the outer perimeter of the iron core piece and the center of the punch for the inner perimeter of the iron core piece. This results in a misalignment between the center of the outer perimeter and the center of the center hole of the iron core piece.

In progressive press devices with multiple rows of punches in both the lower and upper dies, the tendency for misalignment between the center of the outer perimeter and the center of the center hole varies between the rows. Therefore, if blocks formed in different rows are mixed and stacked in the stacked body forming step, the following issues may arise. When blocks are stacked to align the centers of their center holes, the position of the outer perimeter of each iron core piece may vary between blocks. As a result, issues such as increased variation in the dimensional accuracy of the motor core and, consequently, greater inconsistency in motor performance are likely to occur.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method for manufacturing a motor core includes forming multiple blocks. The forming multiple blocks includes: punching iron core pieces from a thin plate-shaped workpiece with multiple progressive press devices; forming, only in an iron core piece that forms one end face of each block, an identifying portion for identifying the progressive press device that forms that block; and forming a block by stacking the punched iron core pieces in each progressive press device. The method further includes stacking the blocks to form a stacked body, and detecting the identifying portion with a detection device prior to the stacking the blocks to form the stacked body. The forming, only in the iron core piece that forms one end face of each block, the identifying portion includes forming the identifying portion in a surface of the iron core piece that forms the one end face of the block. The stacking the blocks to form the stacked body includes stacking, to form the stacked body, only the blocks formed by the progressive press device corresponding to the detected identifying portion among the multiple blocks.

Other features and aspects will be apparent from the following detailed description, the drawings, and the claims.

### BRIEF DESCRIPTION OF THE DRAWINGS

FIG. 1 is a plan view of a stator core manufactured by a motor core manufacturing method according to a first embodiment.

FIG. 2 is an enlarged plan view of an identifying portion of the stator core shown in FIG. 1.

FIG. 3 is a cross-sectional view of the stator core, taken along line 2-2 of FIG. 1.

FIG. 4 is a cross-sectional view of a progressive press device used in the method for manufacturing a stator core shown in FIG. 1.

FIG. 5 is a cross-sectional view showing a state in which an image of one end face of a block is being captured by an identifying device.

FIG. 6 is a cross-sectional view showing a state in which blocks are stacked by a stacked body forming apparatus.

FIG. 7 is a cross-sectional view of a stator core manufactured by a motor core manufacturing method according to a second embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

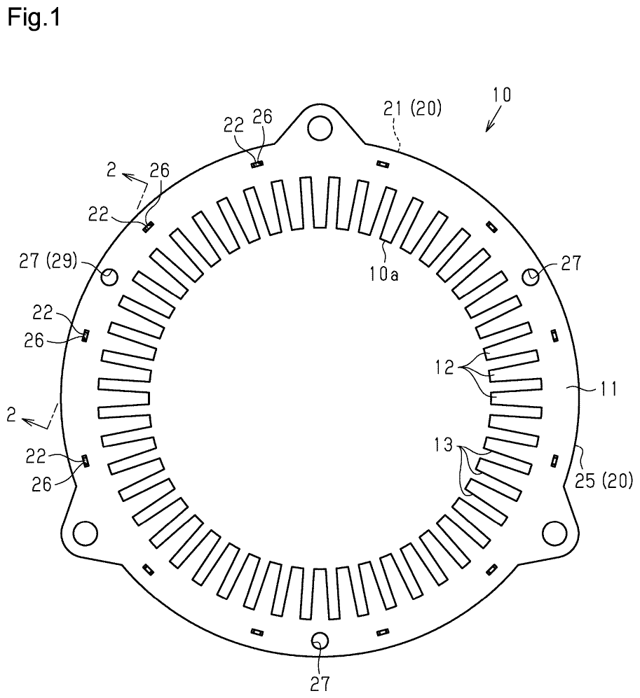

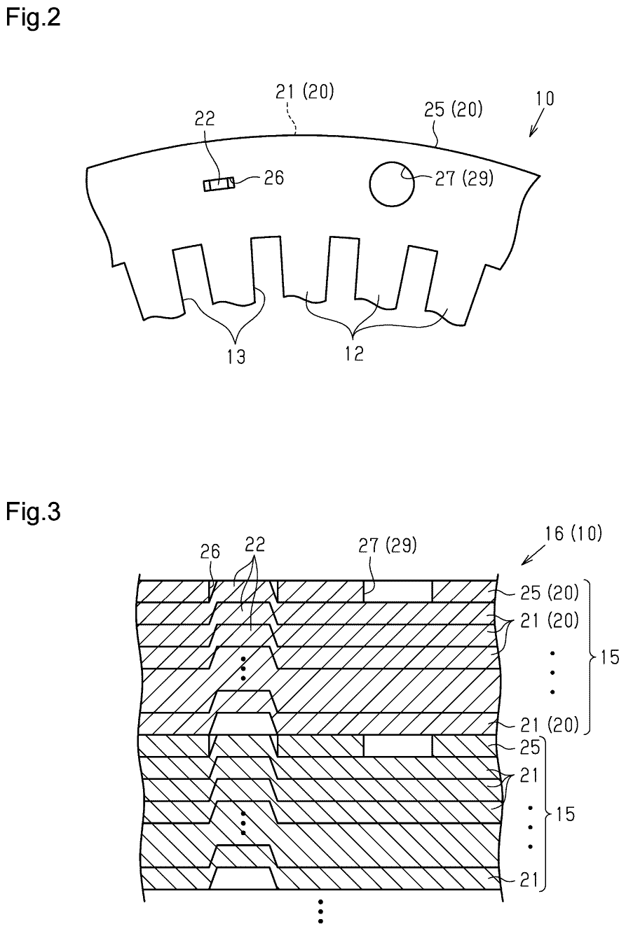

A method for manufacturing a motor core according to a first embodiment will now be described with reference to FIGS. 1 to 6. In the first embodiment, the motor core is a stator core 10.

### Stator Core 10

First, the configuration of the stator core 10 of the present embodiment will be described with reference to FIGS. 1 to 3.

For illustrative purposes, some parts of the structures in the drawings may be exaggerated or simplified.

As shown in FIG. 1, the stator core 10 has a substantially cylindrical shape having a center hole 10a.

As shown in FIG. 3, the stator core 10 includes a stacked body 16, in which multiple blocks 15 are stacked. Each block 15 is formed by stacking multiple iron core pieces 20 made of magnetic steel sheets.

In the following description, the axial direction of the stator core 10 will be referred to as a stacking direction, radial directions of the stator core 10 will simply be referred to as radial directions, and a circumferential direction of the stator core 10 will simply be referred to as a circumferential direction.

As shown in FIG. 1, the stator core 10 includes an annular yoke 11, and multiple teeth 12 that extend radially inward from the yoke 11 and are formed at intervals in the circumferential direction.

A slot 13 is formed between any two of the teeth 12 that are adjacent to each other in the circumferential direction. The slots 13 open inward in the radial direction and extend in the radial direction.

### Iron Core Pieces 20

As shown in FIG. 3, the iron core pieces 20, which form each block 15, include first iron core pieces 21, which are stacked successively, and a second iron core piece 25, which is stacked on one side of the first iron core pieces 21 (upper side as viewed in FIG. 3).

As shown in FIGS. 1 to 3, each first iron core piece 21 includes tabs 22 that bulge toward the second iron core piece 25 in the stacking direction. The tabs 22 are arranged at intervals in the circumferential direction.

As shown in FIG. 3, any two of the first iron core pieces 21 adjacent to each other in the stacking direction are coupled to each other by press-fitting the tabs 22 to each other.

As shown in FIGS. 1 to 3, each second iron core piece 25 has first through-holes 26 and second through-holes 27 that extend through the second iron core piece 25 in the stacking direction.

The tabs 22 of the first iron core piece 21 adjacent to the second iron core piece 25 are fitted into the first through-holes 26.

The first through-holes 26 are spaced apart from each other in the circumferential direction and arranged at positions overlapping with the tabs 22 in the stacking direction (refer to FIG. 1).

The second through-holes 27 are arranged at intervals in the circumferential direction. In the present embodiment, three second through-holes 27 are formed at intervals of 120 degrees around the axis of the stator core 10, that is, at rotationally symmetrical positions. The second through-holes 27 preferably have, for example, a circular shape in plan view.

### Manufacturing Apparatus 100 for Stator Core 10

Next, a manufacturing apparatus 100 for the stator core 10 will be described.

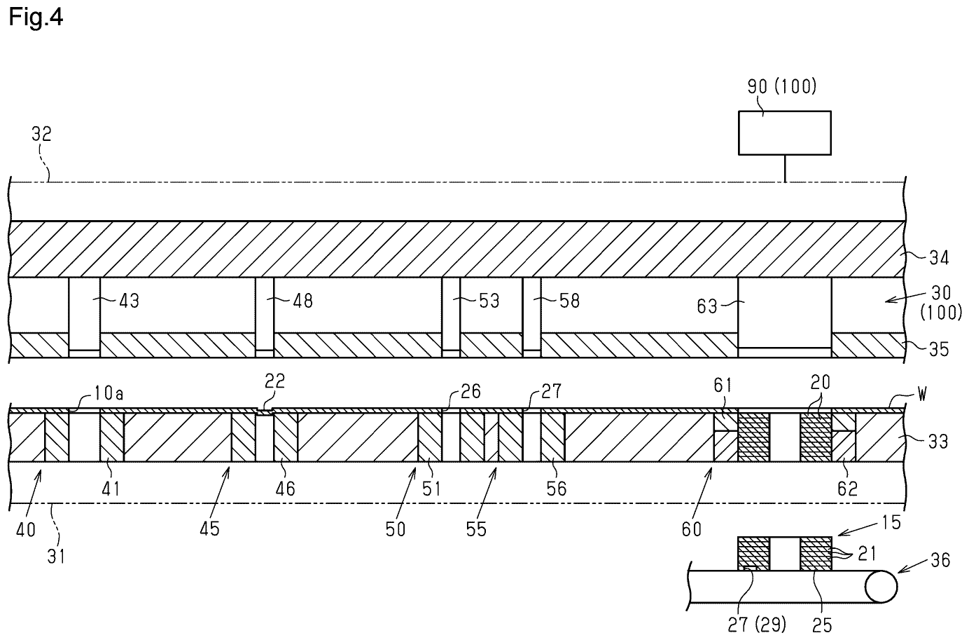

As shown in FIGS. 4 to 6, the manufacturing apparatus 100 includes progressive press devices 30, an identifying device 70, a stacked body forming apparatus 80, and a controller 90.

### Progressive Press Devices 30

As shown in FIG. 4, the progressive press devices 30 are configured to press a thin plate-shaped workpiece W, which is conveyed in a conveying direction (the lateral direction as viewed in FIG. 4) in sequential steps. Each progressive press device 30 punches iron core pieces 20 from the workpiece W, and forms blocks 15 by stacking punched iron core pieces 20.

Although not illustrated, two progressive press devices 30 are arranged in parallel with respect to the conveying direction in the present embodiment. Specifically, the two progressive press devices 30 share a bolster 31, a slide 32, a lower shoe 33, an upper shoe 34, and a stripper plate 35.

The slide 32 is configured to be actuated by an actuator (not shown) to be raised and lowered above the bolster 31.

The lower shoe 33 is fixed to the upper surface of the bolster 31. A thin plate-shaped workpiece W is intermittently conveyed above the upper surface of the lower shoe 33.

The upper shoe 34 is fixed to the lower surface of the slide 32.

The stripper plate 35 is positioned below the upper shoe 34, and is connected to the upper shoe 34 via an elastic member (not shown) so as to be movable in the vertical direction relative to the upper shoe 34.

Iron core pieces 20 are punched from the workpiece W by the two progressive press devices 30, and the punched iron core pieces 20 are stacked in each progressive press device 30 to form blocks 15.

Since the two progressive press devices 30 basically have the same configuration, the configuration of one of the progressive press devices 30 will be described, and the description of the configuration of the other progressive press device 30 will be omitted.

The progressive press device 30 includes a first piercing die 40, a first pressing die 45, a second piercing die 50, a third piercing die 55, and a second pressing die 60, which are arranged in sequence from the upstream side in the conveyance direction (left side in FIG. 4).

The first piercing die 40 is configured to punch a part corresponding to the center hole 10a and parts corresponding to the slots 13 from the workpiece W. The first piercing die 40 includes a first piercing die block 41 and a first piercing punch 43.

The first pressing die 45 is configured to form the tabs 22 in the workpiece W. The first pressing die 45 includes a first pressing die block 46 and a first pressing punch 48.

The second piercing die 50 is configured to punch the first through-holes 26 from the workpiece W. The second piercing die 50 includes a second piercing die block 51 and a second piercing punch 53.

The third piercing die 55 is configured to punch the second through-holes 27 from the workpiece W. The third piercing die 55 includes a third piercing die block 56 and a third piercing punch 58.

The third piercing die 55 is provided only in the one of the two progressive press devices 30, and is not provided in the other.

The second pressing die 60 is configured to punch the iron core pieces 20 from the workpiece W and to form the blocks 15 by stacking the punched iron core pieces 20. The second pressing die 60 includes a second pressing die block 61, a squeeze ring 62, and a second pressing punch 63.

The die blocks 41, 46, 51, 56, 61 and the squeeze ring 62 are fixed to the lower shoe 33. The punches 43, 48, 53, 58, 63 are all fixed to the upper shoe 34.

The second piercing punch 53 is configured to be moved by a drive mechanism (not shown) between a retracted position, at which the second piercing punch 53 does not punch the first through-holes 26 when the slide 32 is lowered, and a punching position, at which the second piercing punch 53 punches the first through-holes 26 when the slide 32 is lowered.

The third piercing punch 58 is configured to be moved by a drive mechanism (not shown) between a retracted position, at which the third piercing punch 58 does not punch the second through-holes 27 when the slide 32 is lowered, and a punching position, at which the third piercing punch 58 punches the second through-holes 27 when the slide 32 is lowered.

In the present embodiment, the blocks 15 are each formed such that the second iron core piece 25, which has the second through-holes 27, is the lower surface.

A conveyor 36 is provided below the second pressing die block 61. The conveyor 36 is configured to convey the blocks 15 extruded downward from the inside of the squeeze ring 62.

The blocks 15 are each conveyed to the downstream side by the conveyor 36, and then placed on an image capturing table 71 (described later) by a robotic arm (not shown).

### Identifying Device 70

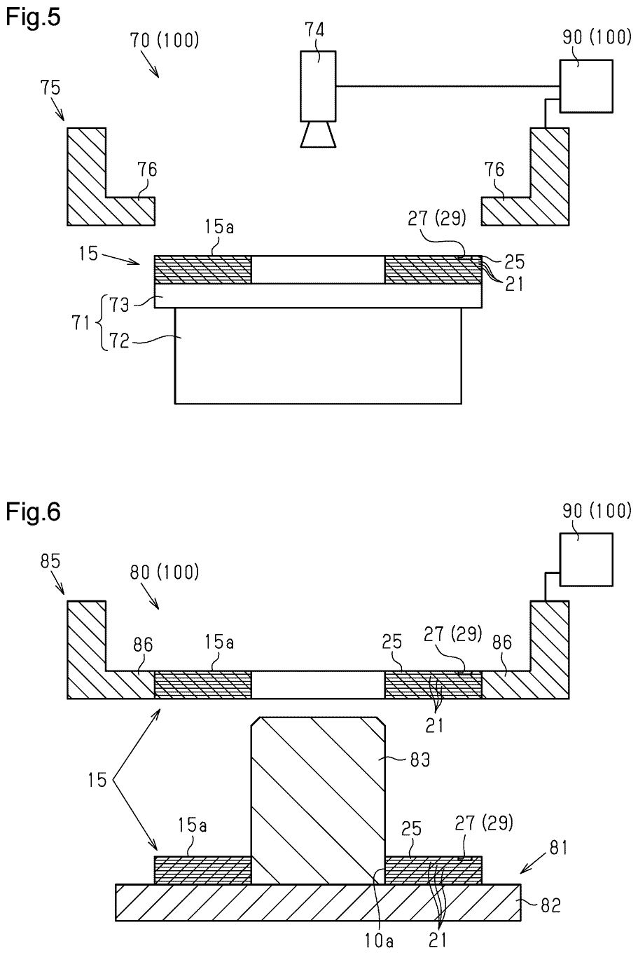

As shown in FIG. 5, the identifying device 70 includes the image capturing table 71, on which the block 15 is placed, an image capturing unit 74 positioned above the image capturing table 71, and an inversion mechanism 75 configured to invert the block 15.

The image capturing table 71 includes a base 72 and a mounting portion 73. The mounting portion 73 is installed on the upper part of the base 72, is rotatably supported by the base 72. The block 15 is placed on the mounting portion 73. The mounting portion 73 is rotationally driven by a motor (not shown).

The image capturing unit 74 is configured to capture an image of the upper end face 15a of the block 15 placed on the image capturing table 71. The image capturing unit 74 includes a known camera.

As described above, the block 15 is placed on the image capturing table 71 with the second iron core piece 25 facing downward.

The inversion mechanism 75 is configured to invert the block 15 such that the second iron core piece 25 faces upward. The inversion mechanism 75 includes a pair of holding portions 76 configured to hold the outer peripheral surface of the block 15 and an elevating mechanism (not shown) configured to raise and lower the holding portions 76. The inversion mechanism 75 is configured to invert the block 15 upside down by rotating the holding portions 76 holding the block 15.

In the present embodiment, the image capturing unit 74 corresponds to a detection device according to the present disclosure.

### Stacked Body Forming Apparatus 80

As shown in FIG. 6, the stacked body forming apparatus 80 is configured to form the stacked body 16 by stacking the blocks 15. The stacked body forming apparatus 80 includes a stacking plate 81 and a transfer unit 85.

The stacking plate 81 includes a plate body 82 having a substantially square shape in plan view, a post portion 83 protruding upward from the center of the plate body 82, and multiple positioning pins (not shown), which are located on the outer side of the post portion 83 and protrude upward from the plate body 82.

The post portion 83 is inserted into the center hole 10a of the block 15. The positioning pins are inserted into specified slots 13 of the block 15 to position the block 15 with respect to the stacking plate 81 in the circumferential direction.

The transfer unit 85 is configured to transfer the block 15 placed on the image capturing table 71 onto the stacking plate 81. The transfer unit 85 includes a pair of holding portions 86 configured to hold the outer peripheral surface of the block 15 and an elevating mechanism (not shown) configured to raise and lower the holding portions 86.

### Controller 90

As shown in FIGS. 4 to 6, the controller 90 is electrically connected to the actuator of the slide 32, the image capturing unit 74 of the identifying device 70, the inversion mechanism 75, the transfer unit 85, and the like.

The controller 90 controls raising and lowering of the slide 32.

When forming a block 15, the controller 90 first drives the actuator of the second piercing die 50 to move the second piercing punch 53 to the punching position. In this state, the controller 90 forms the first through-holes 26 by lowering the slide 32. At this time, the controller 90 moves the third piercing punch 58 to the punching position by driving the actuator of the third piercing die 55. In this state, the controller 90 forms the second through-holes 27 by lowering the slide 32. Subsequently, the controller 90 moves the second piercing punch 53 and the third piercing punch 58 to the retracted positions until the number of times the slide 32 is raised and lowered reaches a specified number of times, that is, until the number of the first iron core pieces 21 reaches the number required to form a block 15. In this state, the first through-holes 26 or the second through-holes 27 are not formed in the first iron core piece 21 when the controller 90 lowers the slide 32.

The controller 90 lifts the block 15 placed on the image capturing table 71 and controls the operation of the inversion mechanism 75 so as to invert the block 15 to an upside-down position.

The controller 90 captures an image of the upper end face 15a of the block 15 with the image capturing unit 74, and detects identifying portions 29 of the block 15 based on the captured image.

The identifying portions 29 for identifying the one of the two progressive press devices 30 are the second through-holes 27 formed in the second iron core piece 25. The identifying portions 29 for identifying the other progressive press device 30 are sections in the second iron core piece 25 that correspond to the second through-holes 27 but lack the second through-holes 27.

The controller 90 controls the operation of the transfer unit 85 so as to stack only the blocks 15 formed by the progressive press device 30 corresponding to the detected identifying portions 29, thereby forming a stacked body 16.

### Method for Manufacturing Stator Core 10

As shown in FIGS. 4 to 6, the method for manufacturing the stator core 10 includes a block forming step, a detecting step, and a stacked body forming step.

### Block Forming Step

As shown in FIG. 4, in the block forming step, iron core pieces 20 are punched from the workpiece W by the progressive press devices 30, and the punched iron core pieces 20 are stacked in each progressive press device 30 to form blocks 15. At this time, only in the second iron core piece 25, which forms one end face (the lower end face in the present embodiment) of a block 15, the second through-holes 27 for identifying the progressive press device 30 that forms that block 15 are formed.

As described above, the block 15 formed in the block forming step is conveyed to the downstream side by the conveyor 36, and then placed on the image capturing table 71 by the robotic arm (not shown).

### Detecting Step

As shown in FIG. 5, in the detecting step, the block 15 is turned upside down by the inversion mechanism 75 so that the second iron core piece 25 faces upward as described above.

An image of the upper end face 15a of the block 15 is captured by the image capturing unit 74. The identifying portions 29 are thus detected.

At this time, based on the image of the upper end face 15a of the block 15, the angular orientation of the block 15 is detected, and the mounting portion 73 is rotated to align the angular orientation of the block 15 with a reference orientation.

As described above, the block 15, which has been set to the reference orientation in the detecting step, is then transferred onto the stacking plate 81 by the transfer unit 85.

### Stacked Body Forming Step

As shown in FIG. 6, in the stacked body forming step, only the blocks 15 formed by the progressive press device 30 corresponding to the identifying portions 29 detected in the detecting step are stacked on the stacking plate 81 to form the stacked body 16.

### Operation of First Embodiment

As shown in FIGS. 4 to 6, mixing multiple blocks 15 formed by different progressive press devices 30 within a single stacked body 16 is prevented. Additionally, only in the second iron core piece 25, which forms the upper end face 15a of a block 15, the identifying portions 29 for identifying the progressive press device 30 that forms that block 15 are formed. This minimizes the number of the iron core pieces 20 in which identifying portions 29 are formed. This configuration minimizes the sections in each block 15 that need to be modified to form the identifying portions 29.

### Advantages of First Embodiment

(1-1) In the block forming step, only in the second iron core piece 25, which forms the upper end face 15a of a block 15, the identifying portions 29 for identifying the progressive press device 30 that forms that block 15 are formed. The identifying portions 29 are formed in a surface of the second iron core piece 25 that forms the upper end face 15a of the block 15. In the detecting step, the identifying portions 29 are detected by the image capturing unit 74 prior to the stacked body forming step. In the stacked body forming step, only the blocks 15 formed by the progressive press device 30 corresponding to the detected identifying portions 29 are stacked to form the stacked body 16.

This method, which operates in the above-described manner, readily reduces the variation in the dimensional accuracy of the stator core 10, and thus the variation in the performance of the motor.

(1-2) The progressive press devices 30 are arranged in parallel and simultaneously punch the iron core pieces 20 from the same workpiece W.

With this method, since multiple blocks 15 are simultaneously formed from the same workpiece W by the progressive press devices 30 arranged in parallel, the blocks 15 are formed efficiently.

(1-3) The two progressive press devices 30 are arranged in parallel. The identifying portions 29 for identifying the one of the two progressive press devices 30, arranged in parallel, are the second through-holes 27 that are formed in the second iron core piece 25 by the one of the two progressive press devices 30. The identifying portions 29 for identifying the other one of the two progressive press devices 30, arranged in parallel, are sections in the second iron core piece 25 that correspond to the second through-holes 27 but lack the second through-holes 27.

With this method, by detecting the presence or absence of the second through-holes 27 formed in the second iron core piece 25 as the identifying portions 29, the one and the other of the two progressive press devices 30 are identified.

(1-4) The second through-holes 27 are formed in the second iron core piece 25 at positions that are rotationally symmetric with respect to the axis of the stator core 10, that is, the axis of the block 15.

When the second through-holes 27 are formed in the second iron core piece 25 as the identifying portions 29, the magnetic flux distribution generated in the stator core 10 may be disturbed.

In this regard, the above-described method forms multiple second through-holes 27 in the second iron core pieces 25 at positions that are rotationally symmetric with respect to the axis of the stator core 10. This suppresses the disturbance of the magnetic flux distribution generated in the stator core 10.

(1-5) In the detecting step, an image of the upper end face of the second iron core piece 25, which forms the upper end face 15a of the block 15, is captured, and the identifying portions 29 are detected based on the captured image.

With this method, the identifying portions 29 are detected by a simple method for detecting the identifying portions 29 based on the captured image of the upper end face 15a of the block 15.

### Second Embodiment

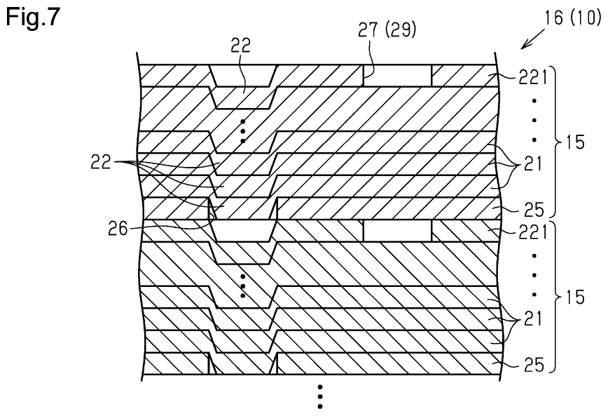

A method for manufacturing a motor core according to a second embodiment will now be described with reference to FIG. 7. In the second embodiment, the motor core is a stator core. The description hereafter will focus on differences from the first embodiment. The present embodiment is different from the first embodiment in that the identifying portions 29 are not provided in the second iron core piece 25, and in that the identifying portions 29 are provided in the iron core piece forming the end face of the block 15 opposite to the second iron core piece 25.

In the following description, components of the second embodiment that are the same as or correspond to those of the first embodiment are denoted by the same reference numerals as those of the first embodiment, and redundant description thereof may be omitted.

As shown in FIG. 7, an upper end face 15a that is an end face of the block 15 on a side opposite to the second iron core piece 25 is formed by a third iron core piece 221. The third iron core piece 221 includes second through-holes 27. The third iron core piece 221 basically has the same configuration as the first iron core piece 21.

In the present embodiment, the identifying portions 29 for identifying the one of the progressive press devices 30 are the second through-holes 27 that are formed in the third iron core piece 221 by the one of the progressive press devices 30. The identifying portions 29 for identifying the other progressive press device 30 are sections in the third iron core piece 221 that correspond to the second through-holes 27 but lack the second through-holes 27.

Further, in the block forming step, only in the third iron core piece 221, the second through-holes 27 for identifying the progressive press device 30 that forms the block 15 are formed. The third iron core piece 221 forms the upper end face 15a of the block 15, which is pushed out downward from the inside of the squeeze ring 62 of the progressive press device 30.

In the detecting step, the inversion mechanism 75 is omitted.

### Operation and Advantages of Second Embodiment

In addition to the advantages (1-1) to (1-5) of the first embodiment, the present embodiment has the advantage described below.

(2-1) The identifying portions 29 are provided in the third iron core piece 221, which forms the end face of the block 15 on the side opposite to the second iron core piece 25.

With this configuration, in the block forming step, the identifying portions 29 are provided in the upper end face 15a of the block 15 pushed out downward from the inside of the squeeze ring 62. This eliminates the need to invert the block 15 placed on the image capturing table 71 after the block forming step, and thus the inversion mechanism 75 can be omitted in the detecting step. This simplifies the manufacturing apparatus 100 for the stator core 10.

### Modifications

The above-described embodiments may be modified as follows. The above-described embodiments and the following modifications can be combined as long as the combined modifications remain technically consistent with each other.

In the first embodiment, an image of the upper end face 15a of the block 15 is captured by the image capturing unit 74. However, an image of the lower end face may be captured. In this case, the step of inverting the block 15 by the inversion mechanism 75 can be omitted.

In each of the above-described embodiments, the shape of the second through-holes 27 is a circular shape in plan view, but the shape of the second through-holes 27 may be a semicircular shape in plan view or a quadrangular shape in plan view.

The number of the second through-holes 27 is not limited to three, and may be one, two, or more than three.

As the number of second through-holes 27 increases, the mass of the stator core 10 decreases, resulting in a trade-off of reduced motor torque. In this regard, when only one second through-hole 27 is provided in the core piece 25, 221, in which the identifying portion 29 is provided, the number of the second through-holes 27 is minimized. This minimizes the reduction in motor torque due to the decrease in the mass of the stator core 10.

In each of the above-described embodiments, the second through-holes 27 are formed at positions in the iron core piece that are rotationally symmetric with respect to the axis of the stator core 10. However, the second through-holes 27 do not necessarily need to be formed at positions that are rotationally symmetric with respect to the axis of the stator core 10. That is, the intervals in the circumferential direction between the second through-holes 27 adjacent to each other in the circumferential direction may vary.

In each of the above-described embodiments, the configuration in which the two progressive press devices 30 are arranged in parallel has been shown. However, a configuration in which three or more progressive press devices 30 are arranged in parallel may be employed. In this case, one of the progressive press devices 30 that has formed the block 15 may be identified by using the identifying portions 29 in the iron core piece 25, 221 that are sections corresponding to the second through-holes 27 but lacking the second through-holes 27. For the other progressive press device 30, the second through-holes 27 may be used as the identifying portions 29 by changing the shape of the second through-holes 27.

In each of the above-described embodiments, the identifying portions 29 in the iron core pieces 25, 221 include the second through-holes 27 and the sections that correspond to the second through-holes 27 but lack the second through-holes 27. However, the types of the identifying portions 29 are not limited thereto. For example, the identifying portions 29 may be formed by tabs. Alternatively, the identifying portions 29 may be formed by notches provided on the outer circumferential surface of the iron core piece 25, 221.

In each of the above-described embodiments, the identifying portions 29 in the iron core pieces 25, 221 include the sections that correspond to the second through-holes 27 but lack the second through-holes 27. However, the present disclosure is not limited thereto. Through-holes as the identifying portions 29 may be provided in each of all the blocks 15 formed by the progressive press devices 30. In this configuration, by differentiating the shape and/or the size of the through-holes of the progressive press devices 30, the progressive press device 30 that forms the block 15 is identified. In this case, the progressive press device 30 that forms the block 15 can be identified by detecting the second through-holes 27 having different shapes and/or different sizes.

In each of the above-described embodiments, the progressive press devices 30 are arranged in parallel and simultaneously punch the iron core pieces 20 from the same workpiece W. However, the progressive press devices 30 may be independent from each other.

The present disclosure may also be employed as a method for manufacturing a rotor core.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A method for manufacturing a motor core, comprising:
forming multiple blocks, including:
punching iron core pieces from a thin plate-shaped workpiece with multiple progressive press devices;
forming, only in an iron core piece that forms one end face of each block, an identifying portion for identifying the progressive press device that forms that block; and
forming a block by stacking the punched iron core pieces in each progressive press device;
stacking the blocks to form a stacked body; and
detecting the identifying portion with a detection device prior to the stacking the blocks to form the stacked body, wherein
the forming, only in the iron core piece that forms one end face of each block, the identifying portion includes forming the identifying portion in a surface of the iron core piece that forms the one end face of the block, and
the stacking the blocks to form the stacked body includes stacking, to form the stacked body, only the blocks formed by the progressive press device corresponding to the detected identifying portion among the multiple blocks.

2. The method for manufacturing a motor core according to claim 1, wherein the progressive press devices are arranged in parallel and simultaneously punch the iron core pieces from a same workpiece.

3. The method for manufacturing a motor core according to claim 2, wherein
the progressive press devices include two progressive press devices arranged in parallel,
the identifying portion for identifying one of the two progressive press devices, which are arranged in parallel, is a through-hole formed in the iron core piece by the one of the progressive press devices, and
the identifying portion for identifying the other of the two progressive press devices, which are arranged in parallel, is a section in the iron core piece that corresponds to the through-hole but lacks the through-hole.

4. The method for manufacturing a motor core according to claim 3, wherein
the through-hole is one of multiple through-holes, and
the forming the identifying portions includes forming the through-holes in the iron core piece at positions that are rotationally symmetric with respect to an axis of the block.

5. The method for manufacturing a motor core according to claim 3, wherein the forming, only in the iron core piece that forms one end face of each block, the identifying portion includes forming only one through-hole in the iron core piece.

6. The method for manufacturing a motor core according to claim 2, wherein
the identifying portion is a through-hole formed in each of all the blocks formed by the progressive press devices, and
at least one of a shape and a size of the identifying portion is different in each of the progressive press devices, which form the blocks.

7. The method for manufacturing a motor core according to claim 1, wherein the detecting the identifying portion includes capturing an image of the one end face of the block and detecting the identifying portion based on the captured image.
